(19) United States
(12) Patent Application Publication
(10) Pub. No.: US 2006/0230570 A1
(43) Pub. Date: Oct. 19, 2006

(54) Exterior all weather mobile video camera housing unit

(76) Inventor: Dewey Claude Parris, Ellijay, GA (US)

Correspondence Address: Dewey Claude Parris, Unit 4260, 747 Mountain Oak Road, Ellijay, GA, 30536, US

(21) Appl. No.: 11/062,332

(22) Filed: Apr. 13, 2005

(51) Int. Cl. B60S 1/44; B60S 1/56

(52) U.S. Cl. 15/250.22; 15/250.41; 348/375

(57) ABSTRACT

The Exterior All Weather Mobile Video Camera Housing Unit consists of a circular clear glass sufficient to allow a 180-degree view from a video camera located inside the glass. This circular glass is stationary and is enclosed on each end to attach component parts that make this unit. The glass is cleaned by four vertical wipe blades attached to a turntable atop the unit powered by an electric motor. A defrost/heat and water cleaning supply from the vehicle's accessory is delivered to the unit. The revolving wipe blades is new and has intermittent speeds. The entire unit is outside the vehicle allowing the video camera to project a real time view to the plasma screen formatted to fit the ex-windshield area inside the vehicle. The windshield is replaced with metal and padding. This will be the first windshieldless vehicle that can be driven.

The unit will be used in conjunction with other invented products in use and could be an improvement to those products.

The primary function of this unit is to provide weather protection to an exterior mobile video camera located inside the unit.

The unit will have a circular clear glass cover sufficient to allow a 180 degrees view at the video camera lense.

This circular glass is stationary and is enclosed on each end to attach component parts that make up this unit.

The glass is cleaned by three vertical rubber blades and one vertical wick blade attached to a turntable located on top of this unit and powered by an electrical motor powered from the vehicle accessory.

The wipe/wick blades maintain contact to the glass shield by spring load at all times, and will operate intermittent or remain on when raining.

A defrost/heat supply from vehicle's accessory will be delivered to inside glass and should clear glass rapidly.

A water spray/cleaning fluid will be located in front of unit and attach to roof keeping the glass sprayed as needed. Spray unit can be attached to unit or other places on the vehicle.

When weather is not a factor unit will be turned off.

An exterior cover shell covers this unit and attaches to top allowing a 100% view from the video camera.

This concept could be the world's foremost safety appliance ever put together in this century.

As mentioned above, this unit will be used in conjunction with other products already in use, namely the plasma screen and a video camera. How these units work together in concert to form a new concept is explained below.

The plasma screen will replace the windshield of the vehicle and be contoured to fit the windshield area.

The exterior where the windshield was removed will be replaced with metal that the vehicle is made of. Behind this metal front will be sufficient padding to aid the airbag system in frontal collisions.

My invention and the video camera will be mounted on the top and to the front of the vehicle, or other places. The video camera will reflect in real-time the actual sight to the plasma screen inside the vehicle.

### Advantages

No windshield or replacement.

No windshield wipers or component parts.

No sun visors.

No glare from sun driving east/west and west/west. Video camera will have filters and night vision capability.

No glare from streetlights and oncoming traffic at night.

Increased protection to passengers in frontal collisions.

This concept can be adapted to vehicles already in use.

This concept can be applied to military, police and possibly to the U.S. President in a more designed fashion.

### Disadvantages

Will not function well in fog/dust storm occurrences.

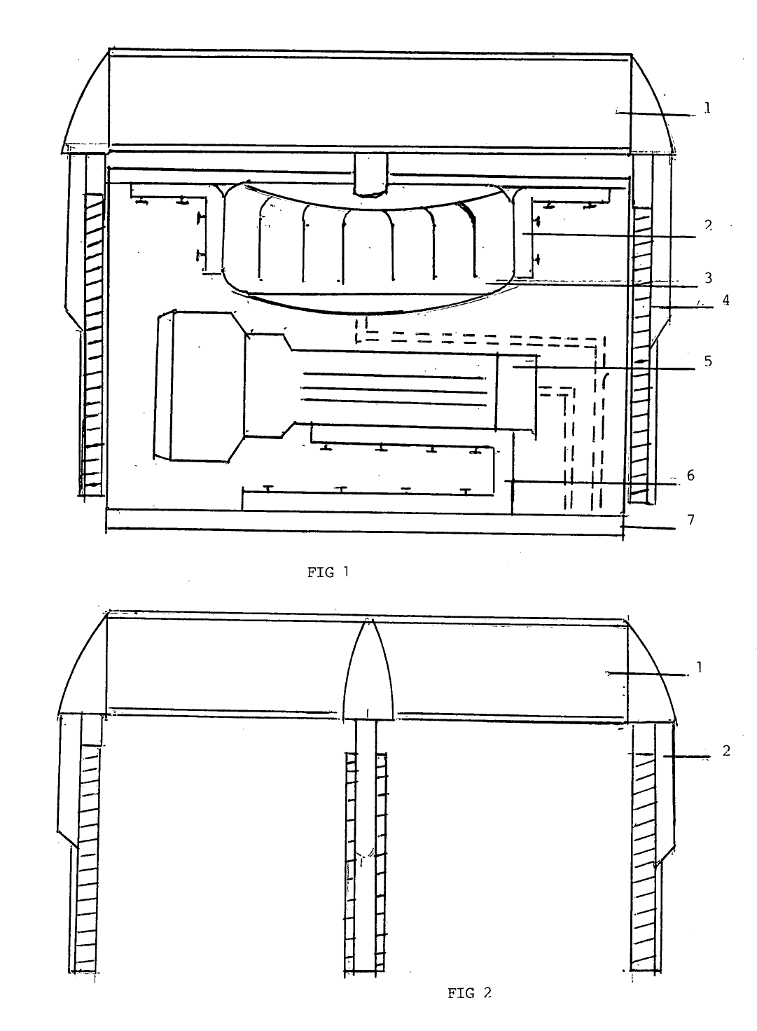

FIG. 1

1. Turntable with wipe blades and wick blade component parts, metal 3/16″ thickness, side thickness ¾″.
2. Bracket assembly securing electrical motor to roof of housing unit. Made of metal. This is a side view of unit.
3. Electric motor.
4. Wipe blade/wick blade assembly in one piece with metal support.

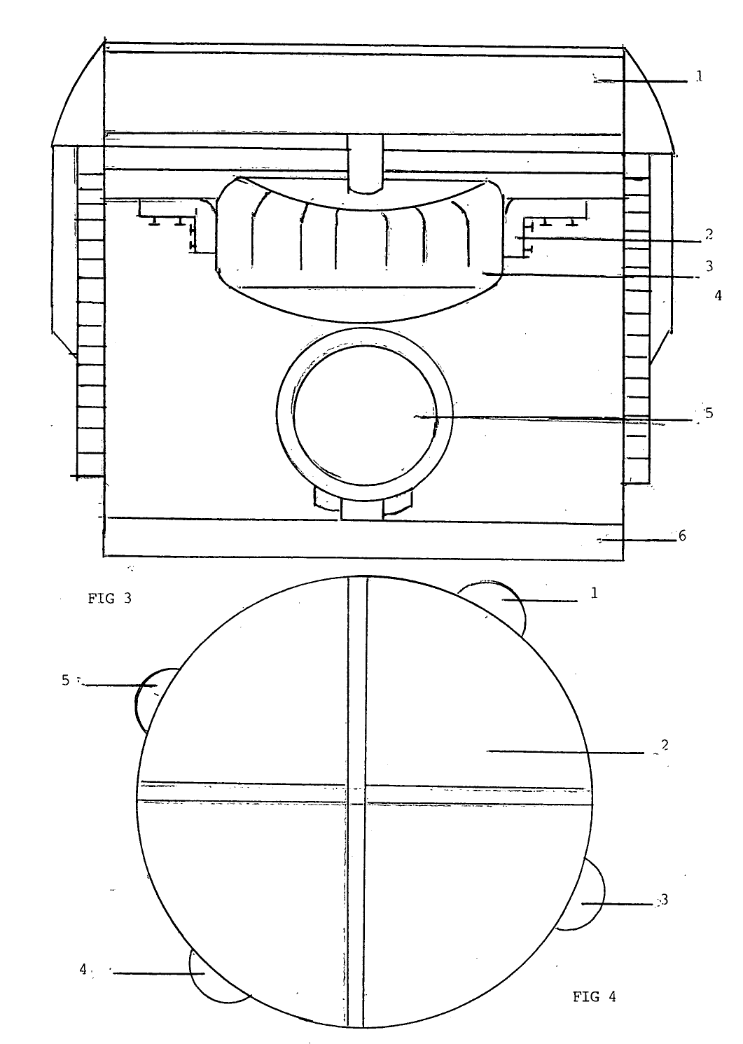

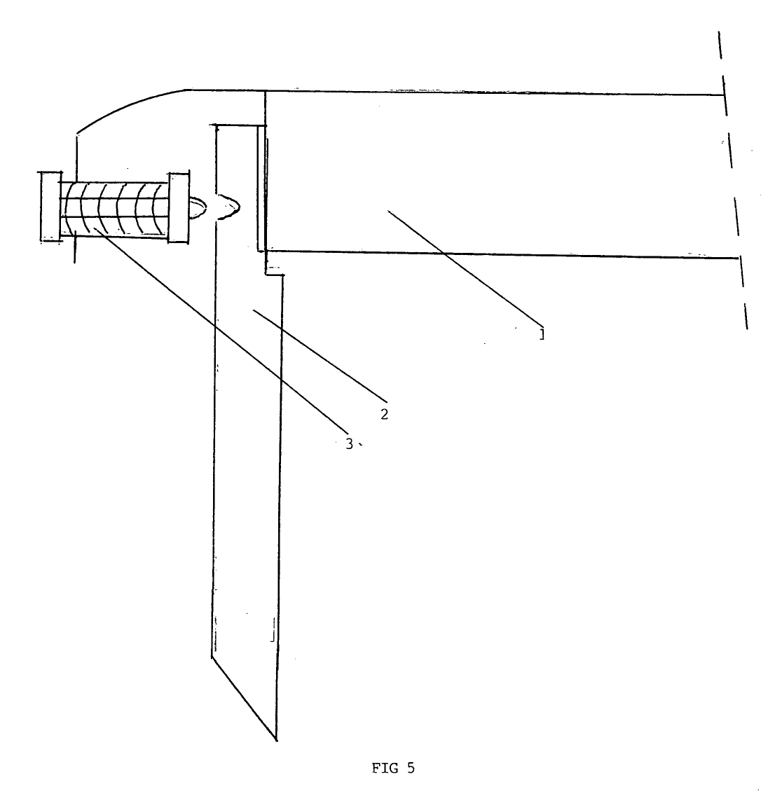

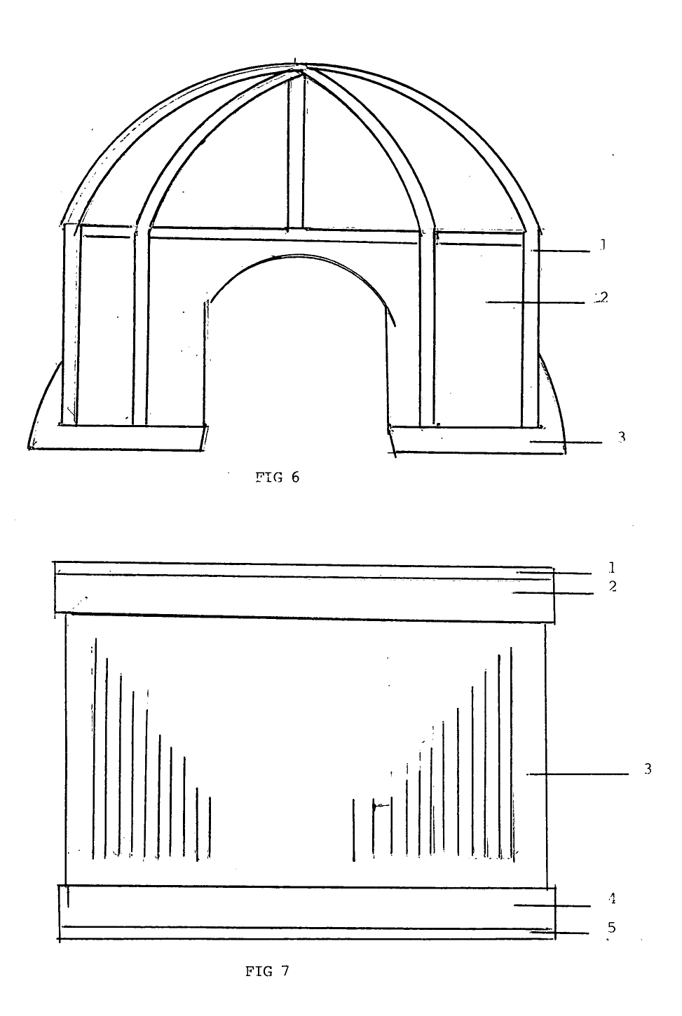

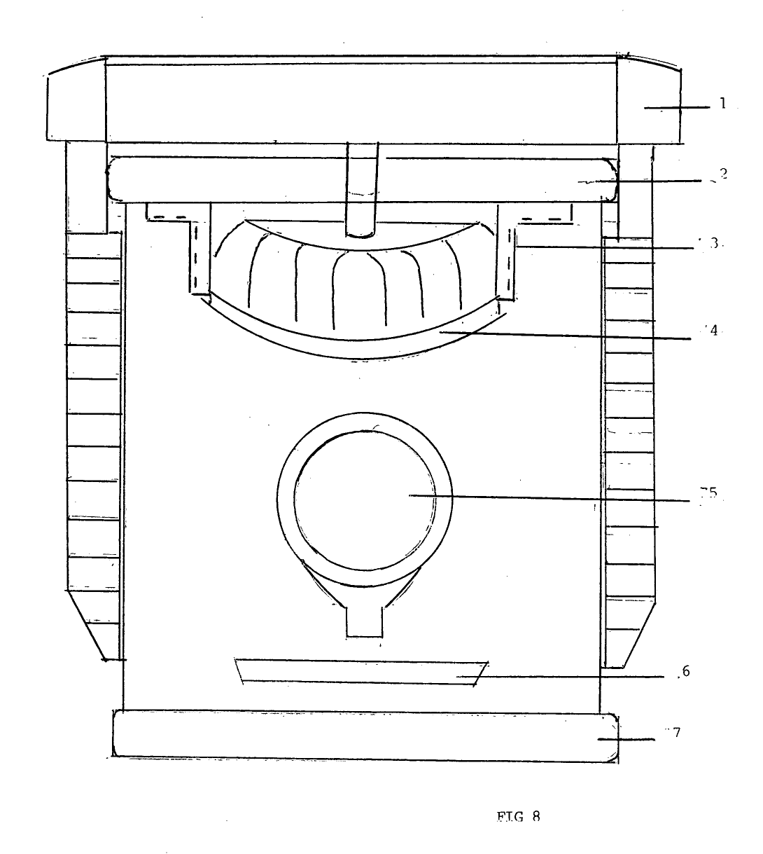

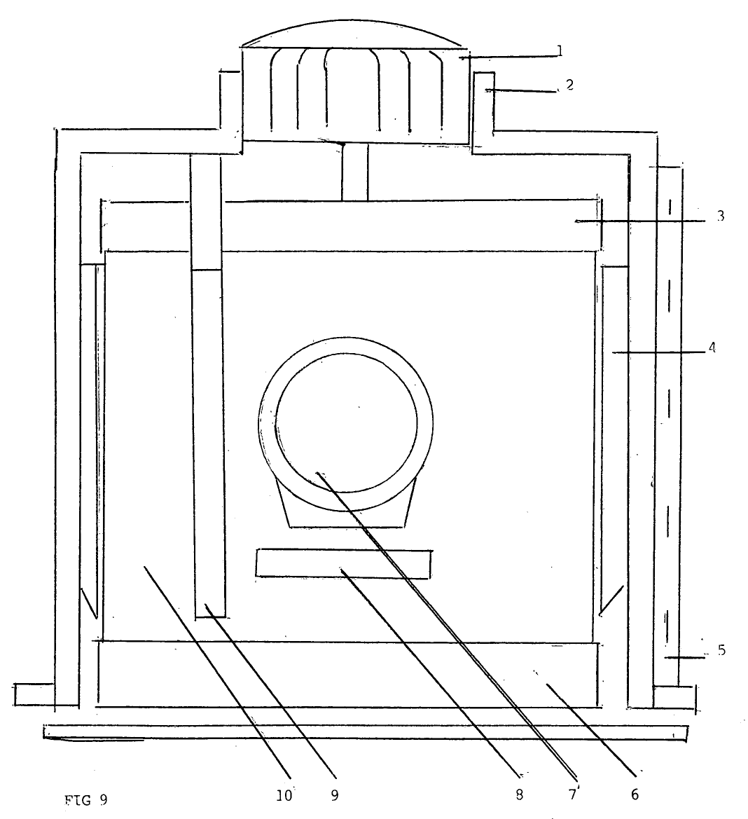

5. Video camera.
6. Bracket support video camera.
7. Base support to glass part of bottom of unit with rubber coating securing a friction fit to circular glass.
   FIG. 2
1. Turntable with wiper/wick component parts made of metal 3/16″ thickness, side thickness ¾″.
2. Wiper blade/wick blade assembly in one piece with metal support.
   FIG. 3
1. Turntable with wiper blades and wick blade component parts metal 3/16″ thickness, side thickness ¾″. This is a front view of unit.
2. Bracket assembly securing electric motor to roof of housing unit. Made of metal.
3. Electric motor.
4. Wipe blade/wick blade assembly in one piece with metal support.
   FIG. 4
1, 3, 4, 5 Wipe blade/wick blade assembly in one piece with metal support. Three wipe blades and one wick blade.
2. Top view of turntable.
   FIG. 5
1. Turntable with expanded view of wipe blades/wick blade assembly.
2. Spring and metal assembly locking in blade assembly to turntable.
3. Metal support to wipe blade/wick blade one piece because of small size of parts.
   FIG. 6
1. Framing for exterior cover shell plastic material.
2. Plastic material secured to framing.
3. Plastic flange to secure unit to vehicle top.
   FIG. 7
1. Metal top to circular glass ⅛″ in thickness
2. Metal side coated with rubber to cause a friction hold on circular glass side thickness ¾″.
3. Circular glass housing component parts of unit electric motor, video camera, defrost and heat, etc.
4. ¾″ metal side coated with rubber to cause a friction hold on circular glass.
5. Metal bottom to circular glass ⅛″ in thickness.
   FIG. 8
1. Turntable with wipe blades and wick blade.
2. Metal top to circular glass, metal side coated with rubber to cause friction hold on glass.
3. Bracket to electrical motor and frame.
4. Electrical motor.
5. Video camera and support.
6. Defrost/heat vent coming from vehicle accessory.
7. Metal side coated with rubber to base of unit.
   FIG. 9 Multiple Dependent Claim:
1. Electric motor vehicle accessory powered.
2. Bracket frame securing electric motor to frame.
3. Metal top to circular glass, metal side coated with rubber to cause friction hold on glass.
4. Stationary wipe blades/wick blade.
5. Exterior water/cleaning fluid unit to spray circular glass as needed.
6. Metal base to circular glass metal side coated with rubber to cause friction hold on glass. This base sits on a sealed bearing race to omit water from entering unit.
7. Video camera and bracket.
8. Defrost/heat vent coming from vehicle accessory.
9. Stationary wick stationed ¼″ from video camera lense.
10. Revolving circular glass housing video camera.

This unit configuration (FIG. 9) differs from the previous claim and is explained in detail following:

This unit is powered by an electrical motor from vehicle accessory. The motor appears on top of the unit and is secured by brackets and frame surrounding the unit. The primary difference of this unit is the circular glass revolves and the cleaning wipe/wick blades are stationary. The glass revolves at a speed that leaves a clear view in front of the video camera. Water cleaning is part of unit located to right side exterior. The base of glass is incorporated into sealed bearing race to prevent water/air to enter unit. Unit is defrosted/heated by vehicle accessory.

1. What I claim as my invention is an exterior all weather mobile video camera housing unit.
The primary function of this unit is to provide weather protection to a mobile video camera located inside the unit. The unit has a clear circular cover sufficient to allow a 180-degree view of the camera lens. This circular glass is stationary and is enclosed on each end to attach component parts, frame and structure. The glass is cleaned by four vertical wipe rubber blades attached to a turntable located on top of the unit, and powered by an electric motor, powered from the vehicle's accessory. The wipe blades maintain contact to the glass shield by spring load at all times and will operate intermittent or remain on when raining. A heat/defrost and spray cleaning fluid (water) comes from the vehicle accessory.
This unit is installed on the top and to the front area of the vehicle, or other places. This unit can recess into the vehicle structure. The unit is made of glass, metal and rubber. When weather is not a factor, the unit is turned off. The video camera being outside the vehicle allows the video camera to project real time view of front and beyond the vehicle to a plasma screen located inside the vehicle and formatted to fit the ex-windshield area. The windshield is replaced by metal and padding. The video camera is equipped with filters and night vision capabilities. These features allow the driver to drive east-west, west-east with no blinding sun glare. The same applies to the night glare from headlights and other lights. If a GPS system is used, this vehicle will show its exact location via home TV, PC computer or telepicture phones.
This unit is a deterrent to theft. It will have a security code to operate its video camera. Unauthorized drivers will be eliminated.
Finally, an end to windshield replacement. The safety appliances make this a very safe vehicle, starting with the exterior video camera housing unit. More ideas are waiting to be discovered.

2. What I claim as my invention is an exterior all weather mobile video camera housing unit that differs from claim #1 in that the structure and operational procedures differ.
In this unit, the four wiper cleaning stations are stationary and the circular glass turns as opposed to being stationary. The wiper stations are important with one station being located ¼ inch from the video camera lens. This station assures the revolving glass will be clear at al times in heavy rain. The wipers will not be seen or heard on the plasma screen inside the vehicle. The bottom component part of this unit is incorporated into a bearing race allowing the unit to turn smoothly and to keep out water and dust.
